(19) United States
(12) Patent Application Publication
(10) Pub. No.: US 2008/0196376 A1
(43) Pub. Date: Aug. 21, 2008

(54) SEPARATOR PLATE FOR POWER TOOL

(75) Inventors: Jerome L. Berti, DeQueen, AR (US); Phyllis Berti, DeQueen, AR (US)

Correspondence Address: PEARNE & GORDON LLP, 1801 EAST 9TH STREET, SUITE 1200, CLEVELAND, OH, 44114-3108, US

(73) Assignee: Husqvarna Outdoor Products Inc., Augusta, GA (US)

(21) Appl. No.: 11/675,328

(22) Filed: Feb. 15, 2007

(51) Int. Cl. A01G 3/053; A01G 3/047; F16H 21/18

(52) U.S. Cl. 56/233; 30/393; 74/55

(57) ABSTRACT

A gearbox for a handheld power tool is provided, including a housing, a main gear disposed within the housing and including a plurality of cams attached thereto. A drive gear is engaged with the main gear for driving the main gear. The gearbox also includes a plurality of cutting members configured to engage the plurality of cams. Rotation of the main gear causes rotation of the cams to thereby cause the cutting members to move in a reciprocal manner. The gearbox also includes a separator plate attached to the housing. A portion of the separator plate is disposed between the plurality of cutting members to inhibit contact between the cutting members. In one example, the separator plate includes a leg section configured to be secured to a portion of the power tool.

### FIELD OF THE INVENTION

The present invention relates to power tools and more particularly, to structure associated with multiple, relatively moving portions within a power tool, such as a hedge trimmer.

### BACKGROUND OF THE INVENTION

A portable trimmer, such as a shoulder-type portable trimmer, a backpack-type portable trimmer, a hedge trimmer or the like, generally employs a driving mechanism which transmits the power generated by an internal combustion engine to a cutter through a gearbox. To operate the portable trimmer, the operator actuates a throttle lever, which in turn controls the power from the internal combustion engine, and thereby drives the cutter through a clutch drum to perform trimming work. Alternatively, an electric motor having generally equivalent throttle control elements can also be used. Conventionally, the cutter included a single reciprocating blade that moved relative to a stationary blade to perform a shearing-type cutting action. In more recent portable trimmers, the cutter can include a pair of alternating, reciprocating blades that can slide past each other to perform the shearing-type cutting action. During operation, it can be beneficial to inhibit various elements within the gearbox, such as rotating elements and/or the reciprocating blades, from contacting each other to alleviate problems due to friction, heat, and/or wear damage.

### BRIEF SUMMARY OF THE INVENTION

The following presents a simplified summary of the invention in order to provide a basic understanding of some aspects of the invention. This summary is not an extensive overview of the invention. It is intended to neither identify key nor critical elements of the invention nor delineate the scope of the invention. Its sole purpose is to present some concepts of the invention in a simplified form as a prelude to the more detailed description that is presented later.

In accordance with one aspect of the present invention, a gearbox is provided for a handheld power tool. The gearbox includes a housing, a main gear disposed within the housing and including a plurality of cams attached thereto, and a drive gear engaged with the main gear for driving the main gear. The gearbox also includes a plurality of cutting members configured to engage the plurality of cams. Rotation of the main gear causes rotation of the cams to thereby cause the cutting members to move in a reciprocal manner. The gearbox also includes a separator plate attached to the housing. A portion of the separator plate is disposed between the plurality of cutting members to inhibit contact between the cutting members.

In accordance with another aspect of the present invention, a gearbox is provided for a handheld power tool. The gearbox includes a housing, a main gear disposed within the housing and including a pair of eccentric cams attached thereto, and a drive gear engaged with the main gear for driving the main gear. The gearbox also includes a pair of cutting members configured to engage the pair of cams. Rotation of the main gear causes rotation of the cams to thereby cause the cutting members to move in a reciprocal manner. The gearbox also includes a separator plate including a main portion and a leg section. The leg section is secured to the housing and the main portion is disposed between the pair of cutting members to inhibit contact between the cutting members.

In accordance with another aspect of the present invention, a separator plate for use with a handheld power tool having a plurality of gears for driving a plurality of cutting members is provided. The separator plate includes a main portion having a hole extending therethrough, and a leg section attached to the main portion. The leg section is configured to be secured to a portion of the power tool. The main portion is configured to be disposed between the plurality of cutting members to inhibit contact between the cutting members.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a perspective view of a portable trimmer in accordance with an aspect of the present invention;

FIG. 2 is a partial sectional view generally along line 2-2 of FIG. 1 illustrating an example gearbox in accordance with an aspect of the present invention;

FIG. 3A is a side view of an example main gear in accordance with an aspect of the present invention;

FIG. 3B is a top view of the example main gear shown in FIG. 3A;

FIG. 4 is a bottom view of the example gearbox of FIG. 2;

FIG. 5 is a side section view showing some of the components shown in FIG. 2;

FIG. 6A is a top view of an example separator plate in accordance with an aspect of the present invention;

FIG. 6B is a side view of the example separator plate shown in FIG. 6A;

FIG. 7 is an enlarged view similar to FIG. 2, but specifically provides a perspective view of the separator plate disposed between a pair of example cutting members;

FIG. 8 is a partial detail view of components shown in FIG. 4;

FIG. 9 illustrates a perspective view of the housing; and

FIG. 10 is an inverted and enlarged section view of some of the components shown in FIG. 5, and specifically illustrates an example interaction between a main gear and the housing.

### DESCRIPTION OF EXAMPLE EMBODIMENTS

Example embodiments that incorporate one or more aspects of the present invention are described here and illustrated in the drawings. These examples are not intended to be a limitation on the present invention. For example, one or more aspects of the present invention can be utilized in other embodiments and even other types of devices.

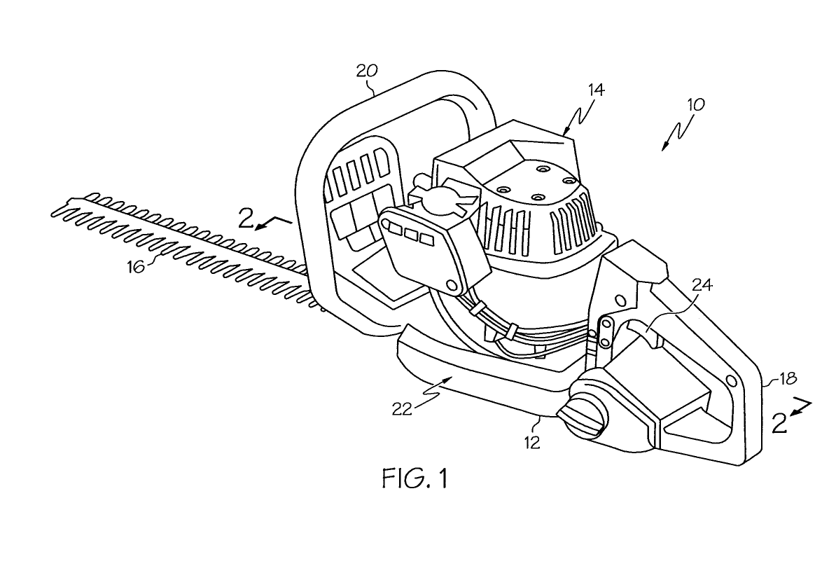

Referring initially to FIG. 1, there is shown a perspective view of an example handheld hedge trimmer 10 incorporating some aspects of the present invention. Although the described example is a hedge trimmer, it should be understood that the present invention could be incorporated into any suitable type of power tool or power equipment and is not limited to use merely in a hedge trimmer and, may be incorporated in different types of embodiments. In addition, any suitable size, shape or type of elements or materials could be used.

The hedge trimmer 10 generally includes a frame 12, an engine 14 connected to the frame 12, and a cutter 16. As shown, the cutter 16 includes a pair of alternating, reciprocating cutting blades, though various other blade configurations including various numbers of cutting blades can also be used. The frame 12 can be made of metal, plastic, or the like and can include a rear handle section 18 and/or a front handle section 20. The engine 14, in the embodiment shown, is an internal combustion engine. However, any other suitable motor (e.g., an electric motor) could also be provided. The engine 14 is fixedly connected to the frame 12. A gearbox 22 is operatively connected to the engine 14, and is configured to transfer engine power to drive the cutter 16. The trimmer 10 has a throttle device, attached to the frame 12, which has a throttle trigger 24 at the rear handle section 18, and a clutch (not shown) located in the frame 12 that connects the engine 14 to the cutting blade 16. The throttle trigger 24 is generally biased in a home position or a relatively lower motor speed position via a trigger spring (not shown). The trigger spring is typically a coiled spring located in the rear handle section 18; however, any suitable means to bias the trigger 24 at its relatively lower motor speed position can be provided.

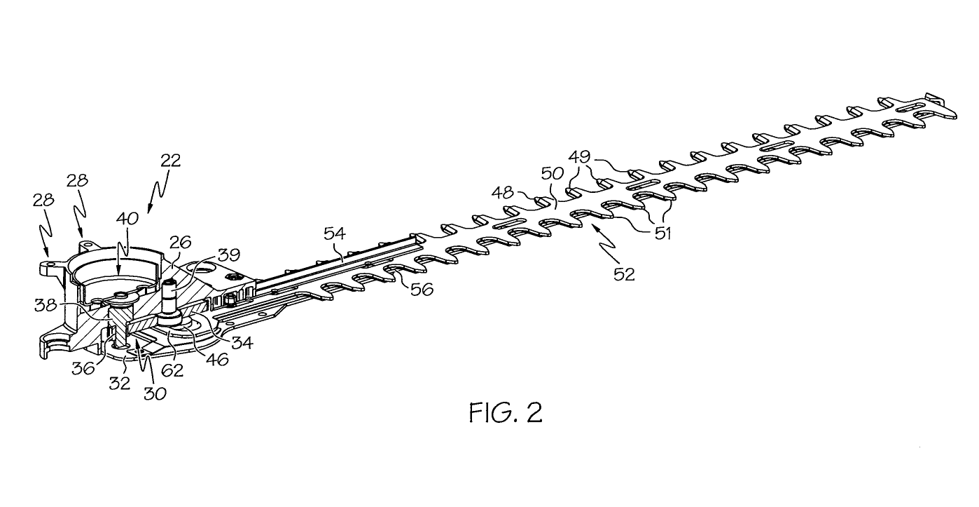

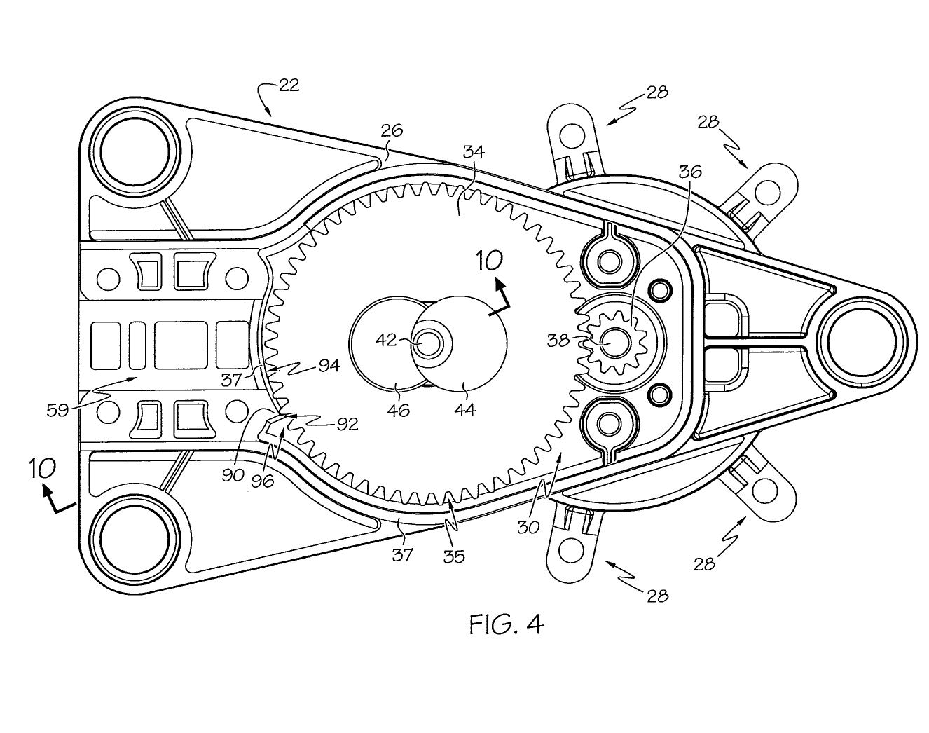

Turning now to FIGS. 2 and 4, example details of the gearbox 22 are shown. For the sake of clarity, only a sectional view of a portion of the gearbox 22 is shown; the cutter 16 is shown in its entirety, and various aforementioned elements of the hedge trimmer 10 have been removed. The gearbox 22 can include a housing 26 that can be fixedly attached to either or both of the frame 12 or the engine 14, such as through various fasteners or the like extending through mounting holes 28, though the gearbox 22 can also be removed there from to permit maintenance and/or replacement of elements within the gearbox 22. The gearbox 22 can include an interior area or recess 30 bounded on one side by the housing 26, and on the other side by a removable plate 32 or the like that can be attached thereto. Additionally, the recess 30 can be bounded by a wall section 37 that can extend about a portion or the entirety of the recess 30. The wall section 37 can be continuous or disjoint, and can have various geometries.

A main gear 34 having a plurality of gear teeth 35 is disposed within the recess 30, and a drive gear 36 is engaged with the main gear 34 for driving the main gear 34. In the shown example, both of the main and drive gears 34, 36 are spur gears, though various other types of gears can also be used, such as helical gears, bevel gears, worm gears, crown gears, differential gears, planetary gears, etc. The drive gear 36 is mounted to or formed with a shaft 38 that is operatively connected to a power transfer device 40 for transferring power from the engine 14 to the drive gear 36. For example, the power transfer device 40 can include a direct connection to the output of the engine 14 (e.g., a direct connection to an engine crankshaft, not shown), though it can also include an indirect connection to the engine 14, such as through gearing or the like for modifying speed and/or torque (not shown), and/or a clutch device or the like (e.g., a centrifugal clutch, not shown). Additionally, either or both of the main gear 34 and the drive gear 36 can be rotationally supported by various bushings, bearings, or the like. For example, a shaft 42 of the main gear 34 can be supported by one or more needle bearings 39.

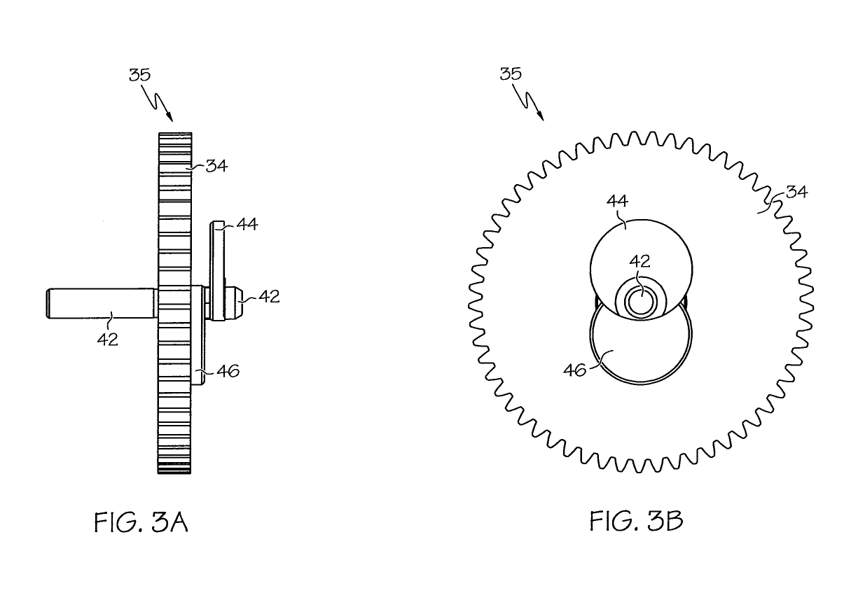

Turning briefly to FIGS. 3A-3B, the shaft 42 can be attached to or formed with the main gear 34 such that rotation of one causes corresponding rotation of the other. As shown, the shaft 42 can extend through the gear 34 so as to project out a distance from both faces of the gear 34, though it is to be appreciated that the shaft 42 could include two shafts, each extending from an opposite face of the gear 34. The main gear 34 also has a plurality of cams 44, 46 attached thereto. In the shown example, the first and second cams 44, 46 are fixedly attached to the shaft 42 so as to rotate therewith for driving the cutter 16, though either of the cams 44, 46 can also be attached to the main gear 34. Additionally, as shown, both of the cams 44, 46 have a generally circular geometry and are eccentrically mounted to the shaft 42 such that the eccentrics are located in a diametrically-opposed manner. Further, one of the cams is mounted above the other. However, it is to be appreciated that any number of cams having various geometries (e.g., elliptical, square, rectangular, triangular, polygonal) can be arranged in various manners relative to each other depending upon the desired action of the cams for driving the cutter 16.

Turning back now to FIG. 2, the cutter 16 of the hedge trimmer 10 can include various elements. As shown, the cutter 16 can include a plurality of cutting members 48, 50, one being located vertically above the other. Each cutting member 48, 50 can have a plurality of cutting teeth 49, 51, respectively. Each tooth 49, 51 can include a sharpened and/or serrated edge so as to provide a shearing-type cutting action as the first and second cutting members 48, 50 reciprocate relative to each other. Thus, items to be trimmed, such as plant foliage or the like (not shown), can be trimmed by the shearing-type cutting action when located within a gap 52 between adjacent teeth 49, 51,

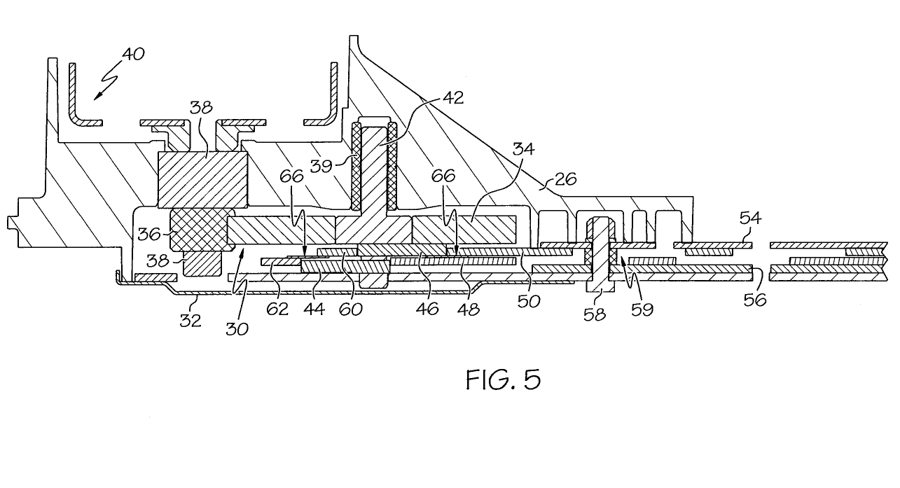

The cutter 16 can also include various other elements to facilitate alignment of the first and second cutting members 48, 50 relative to each other. For example, the cutter 16 can include a top bar 54 and a bottom bar 56, and an intermediate bar (not shown) may also be included to maintain spacing between the first and second cutting members 48, 50. Additionally, as shown in FIG. 5, one or more retainers 58 can extend through the top bar 54, the first and second cutting members 48, 50, and the bottom bar 56 to maintain longitudinal and/or transverse alignment of the various elements. At least one of the retainers 58 can be located within a transition area 59 of the housing 26 through which a portion of each of the cutting members 48, 50 alternately moving in and out of the housing 26.

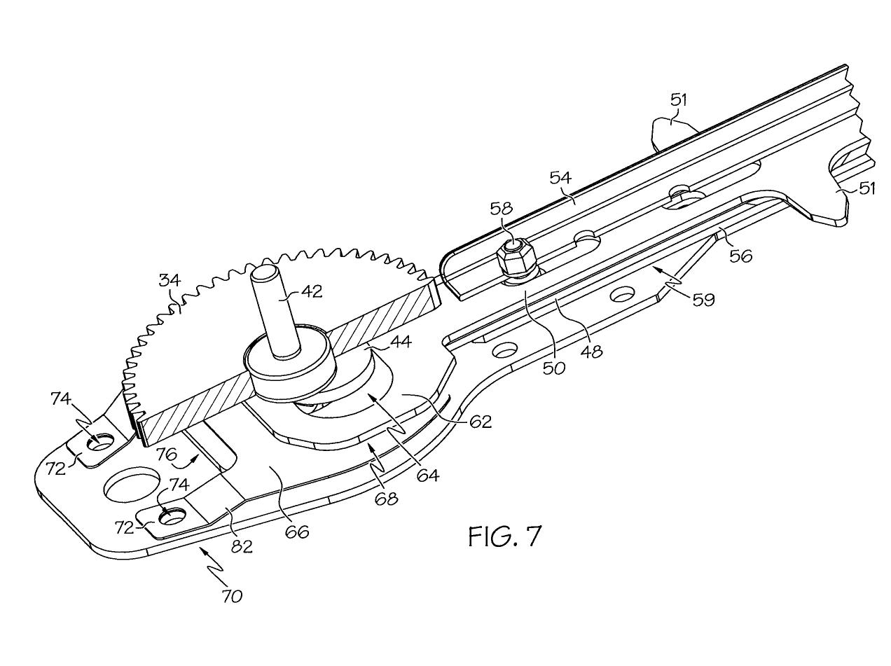

Turning now to FIG. 7, each of the first and second cutting members 48, 50 can include a driven end 60, 62, respectively, for being driven by the first and second cams 44, 46, respectively. It is to be appreciated that FIG. 7 is similar to FIG. 2, though even more structure has been removed for the sake of clarity. As shown, the first and second driven ends 60, 62 can include an enlarged portion having a hole 64 extending there through for receiving one of the cams. Each hole 64 can include an oblong geometry having curved interior corners to facilitate rotation of the cam received therein. As can be appreciated, rotation of the main gear 34 causes corresponding rotation of the first and second cams 44, 46 to thereby cause the first and second cutting members 48, 50 to move in a reciprocal manner. Thus, as the cam rotates within the hole 64, an exterior surface of the cam drives against the interior surface of the hole 64 to cause movement of the cutting member relative to the housing 26. Because the cams 44, 46 are arranged in an eccentric, diametrically-opposed manner, the cutting members 48, 50 will move in an alternating, generally linear reciprocal manner.

However, because of the close spacing of the various elements within the gearbox 12, it can be beneficial to inhibit various elements, such as rotating elements and/or the reciprocating blades, from contacting each other to alleviate problems due to friction, heat, knocking, wear damage, or the like. Accordingly, as shown in FIG. 7, the hedge trimmer 10 can also include a separator plate 66 having a portion 68 disposed between the plurality of cutting members 48, 50 to inhibit contact between the cutting members 48, 50. The portion 68 can act as an intermediate member between the cutting members 48, 50 and the cams 44, 46, such that one surface of the cutting members 48, 50 and the cams 44, 46 ride upon the surface of the portion 68 of the separator plate 66. The separator plate 66 can be manufactured using known stamping or molding operations, though other hot or cold working operations can also be used. Additionally, if the separator plate 66 includes a material that is relatively softer than the materials of the cutting members 48, 50 and the cams 44, 46, the separator plate 66 will wear relatively faster, and can be easily replaced when necessary. Further still, a lubricant, such as grease, oil, or the like, can be contained within the gearbox 22, and the portion 68 can provide a location for the lubricant to be spread about for lubricating the cams 44, 46 and/or the cutting members 48, 50.

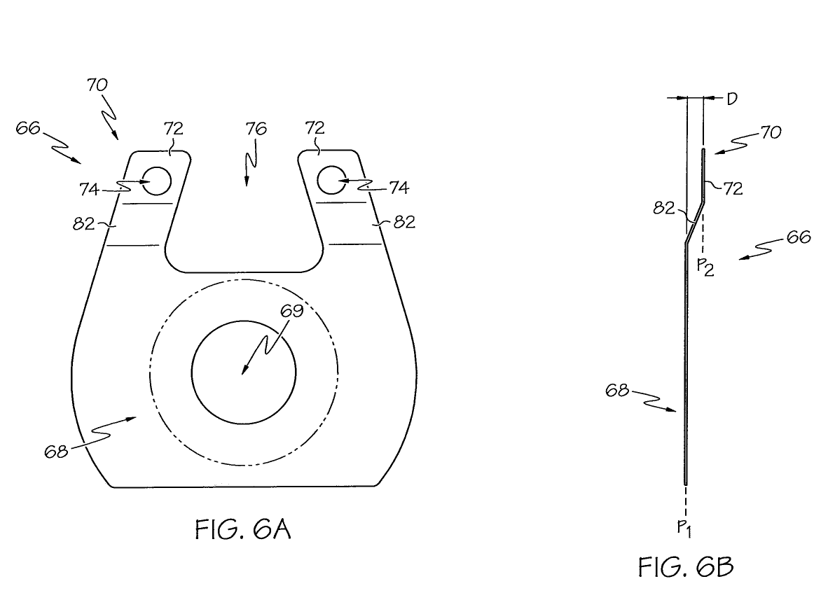

As shown in FIG. 6A, 6B, and 7, one end 70 of the separator plate 66 can be attached directly or indirectly to the housing 26, while a major portion 68 of the plate is spaced a distance from the housing 26. The one end 70 can include one or more leg sections 72. For example, as shown, the one end 70 includes a pair of leg sections 72 projecting from the major portion 68 and each having a mounting hole 74 for securing the separator plate 66. In one example, the leg sections 72 can be secured to the removable plate 32, though various other mounting locations can also be used, such as the gearbox housing 22. The leg sections 72 can be spaced a distance apart to create an aperture 76 there between to accommodate the drive gear 36 and/or its shaft 38 within the gearbox 22. Further, the major portion 68 can include a hole 69 extending there through for receiving the shaft 42 of the main gear 34. The hole 69 is generally large enough to permit the shaft 42 to extend there though, but generally small enough to inhibit either of the cams 44, 46 from passing there through. As shown in phantom in FIG. 6A, the size (e.g., diameter) of the hole 69 can vary depending upon the particular geometry of the various gearbox elements, such as the cams 44, 46 or the cutting members 48, 50. Additionally, the hole 69 can have various other geometries.

Because the ends of the leg sections 72 can be secured to the removable plate 32, and because the removable plate 32 can be spaced a distance from the first and second cutting members 48, 50, the leg sections 72 can be similarly offset relative to the major portion 68. For example, as shown in FIGS. 6A-6B, the major portion 68 can extend along a first plane P₁, while the end 70 including the leg sections 72 can extend along a second plane P₂. As shown, the first plane P₁ can be spaced a distance D vertically from the second plane P₂. The vertical offset distance D can be provided by an intermediate leg portion 82 on each of the leg sections 72 that is angled relative to the major portion 68. The angled intermediate leg portions 82 can provide flexure to the separator plate 66 to permit the major portion 68 to flex in a vertical direction to vary the distance D. As such, the separator plate 66 can adjust to movement of the various elements and/or absorb vibrations that can be created during operation of the hedge trimmer 10 as the cams 44, 46 rotate and the cutting members 48, 50 correspondingly reciprocate. It is to be appreciated that the foregoing description and the various figures are not intended to provide a limitation upon the separator plate 66, and as such it can include various other features, geometries, properties, or the like.

Turning now back to FIG. 4, as stated previously, a lubricant, such as grease, oil, or the like, can be contained within the gearbox 22 for lubricating the cams 44, 46 and/or the cutting members 48, 50. However, during operation, the alternating, reciprocating action of the cutting blades 48, 50 moving in and out of the gearbox 22, can cause lubrication contained within the gearbox 22 to be drawn out or thrown out of the gearbox 22. For example, the reciprocating action of the cutting blades 48, 50 can draw or force lubrication from the recess 30, into the transition area 59 of the housing 26, and out of the gearbox 22. As such, it can be beneficial to include a lubrication retention apparatus in order to counteract a loss of lubricant from the gearbox 22.

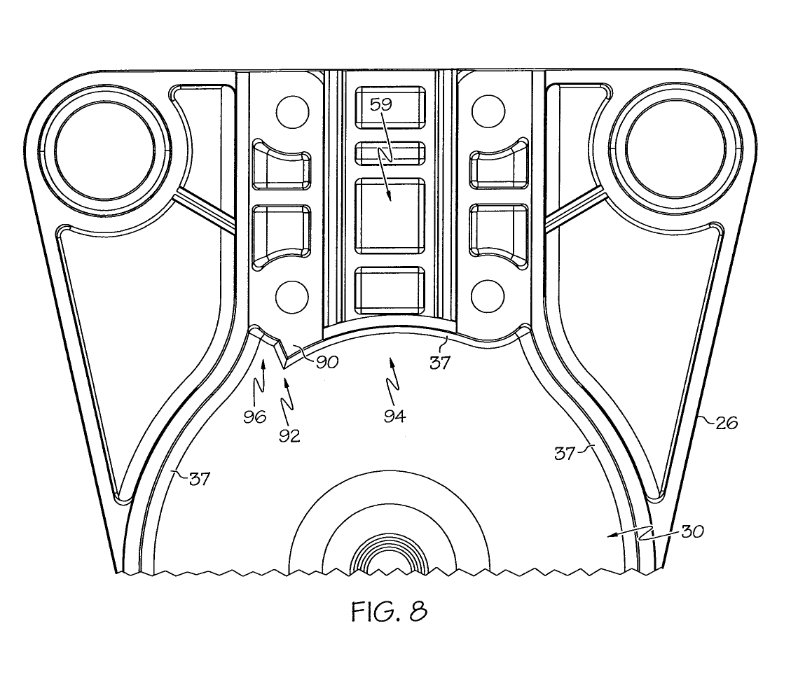

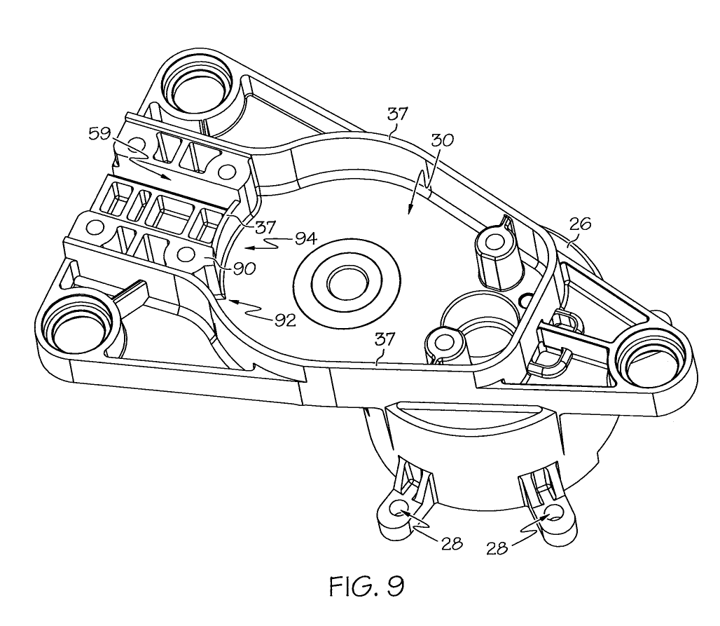

Thus, the gearbox 22 can include means for retaining lubricant within the housing for improved retention of the lubricant on at least the main gear 34 and/or the separation plate 66, though it can also improve retention on other elements, such as the cams 44, 46 and/or the cutting blades 48, 50. In one example, the means for retaining can be configured to create a localized pressure reduction within the housing 26 during operation of the power tool 10. As shown in FIGS. 8-9, the means for retaining can include a projection 90 attached to a portion of the wall section 37 of the recess 30. It is to be appreciated that FIG. 8 is similar to FIG. 4, except that the gears and other elements located within the housing 26 have been removed for the sake of clarity. The projection 90 can be a separate element that is fixedly or removably attached to a portion of the wall section 37, such as by fasteners, adhesives, a snap connection, an interference fit, or the like, and/or can even be formed with the wall section 37. The projection 90 can extend towards the main gear 34, and can include an end 92 located adjacent to the main gear 34.

The projection 90 and the end 92 can each include various geometries. For example, the projection 90 can include one or more projections extending at various angles relative to the wall section 37. The end 92 can include a tapered geometry that converges to a point (e.g., a triangular geometry), as shown, though it can also include a generally flat, curved, or serrated geometry. Additionally, the gearbox 22 can include a plurality of projections 90 located variously within the recess 30 to create a plurality of localized pressure reductions therein.

Because the recess 30 of the gearbox 22 is generally filled with air, movement of any of the main gear 34, cams 44, 46, and/or cutting blades 48, 50 can cause movement of the air within the recess 30. Further, because air is a fluid, it is subject to the Bernoulli effect and/or the Venturi effect. That is, when a flowing fluid passes through a restriction, the streamlines of the fluid are forced closer together and simultaneously the flow velocity increases and the pressure decreases. As the pressure of the fluid decreases, a localized pressure reduction is formed. It is to be appreciated that, due to the Bernoulli effect and/or the Venturi effect, the faster the fluid's velocity, the lower the pressure differential. As such, the faster that the main gear 34 spins and moves the air within the recess 30, the greater the localized pressure reduction (e.g., the greater the decrease in pressure) about the projection 90.

In the shown example, the flow restriction can be caused by the projection 90 that extends towards the main gear 34. Specifically, the flow restriction can be located about the end 92 of the projection 90, and as such, the localized pressure reduction can be formed proximate the end 92 and the main gear 34. The localized pressure reduction can facilitate retention of the lubricant within the gearbox 22 by inhibiting the lubricant from exiting the gearbox 22 through the transition area 59, and/or the pressure reduction can even draw errant lubricant, such as lubricant that has been drawn or forced into the transition area 59, back into the recess 30.

Additional structure can also be included to facilitate the creation and/or maintenance of the localized pressure reduction. For example, a portion of the wall section 37 adjacent the projection 90 can include a curved geometry 94 that curves towards the main gear 34. The curved geometry 94 can have various shapes. For example, the curved wall section 94 can curve towards the main gear 34 at an increasing rate of curvature to permit a more controlled fluid flow within the recess 30. As shown in FIGS. 8-10, the curved wall section 94 can curve towards the main gear 34 at an increasing rate of curvature that culminates at the end 92 of the projection 90 located at a minimum distance G between the curved wall section 94 and the main gear 34. Thus, the localized pressure reduction can be formed proximate the minimum distance G between the curved wall section 94 (e.g., the end 92 of the projection 90) and the main gear 34 during operation thereof. It is to be appreciated that the localized pressure reduction may or may not be formed exactly at the point of minimum distance between the curved wall section 94 and the main gear 34, but will at least be formed proximate (i.e., in the vicinity of) the minimum distance G.

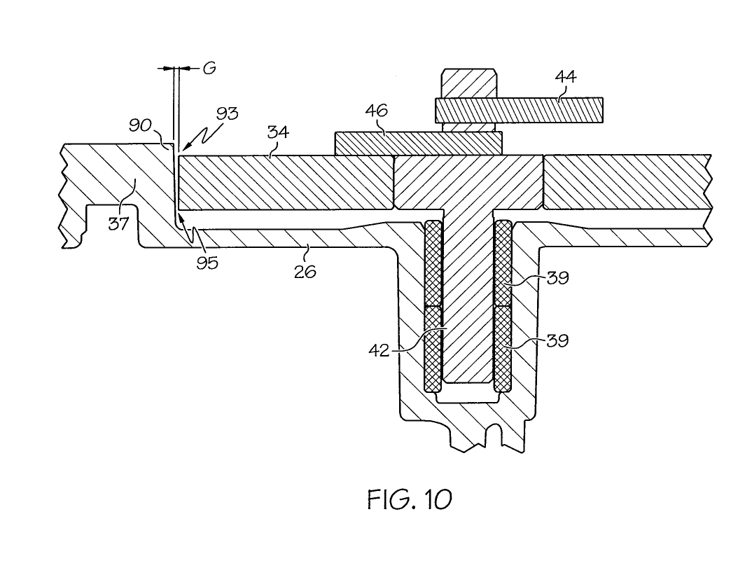

Further, the curved wall section 94 can subsequently diverge away 96 from the main gear 34 to better emphasize the restriction to thereby emphasize the localized pressure reduction. For example, as shown in FIG. 8, the curved wall section 94 can increasing curve towards the tip 92 of the projection 90, and then quickly diverge away 96 there from. Even further still, the projection 90 and/or the curved wall section 94 can taper either towards or away from the main gear 34 along at least the vertical axis. For example, as shown in FIGS. 9-10, the projection 90 can taper away from the main gear 34 such that the distance there between is relatively greater towards the top 93 of the main gear 34, and relatively lesser towards the bottom 95 of the main gear 34. Such tapering can be located at the projection 90, such as at the tip 92, or can also extend a distance along the wall section 37. It is to be appreciated that such tapering can have various geometries, such as linear, curved, or polygonal.

During operation, the engine 14 drives the drive gear 36, which drives the main gear 34 and causes the cams 44, 46 to rotate. Rotation of the first cam 44 within the first driven end 60 causes corresponding reciprocal motion of the first cutting member 48, and similarly, rotation of the second cam 46 within the second driven end 62 causes corresponding reciprocal motion of the second cutting member 50. During rotation of the cams 44, 46 and reciprocation of the cutting members 48, 50, the separator plate 66 can inhibit contact between a superjacent cutting member (e.g., the second cutting member 50) and a subjacent cutting member (e.g., the first cutting member 48). The separator plate 66 can further inhibit contact between a superjacent cam (e.g., the second cam 46) and a subjacent cam (e.g., the first cam 44). Additionally, rotation of the cams 44, 46 and reciprocation of the cutting members 48, 50 can cause the lubricant within the gearbox 22 to be spread about the separation plate 66 for lubricating the cams 44, 46 and/or the cutting members 48, 50. Further, rotation of the main gear 34 past the end 92 of the projection 90 can create a localized pressure reduction to thereby retain, and/or draw, lubricant within the recess 30 of the gearbox.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A gearbox for a handheld power tool, including:
a housing;
a main gear disposed within the housing and including a plurality of cams attached thereto;
a drive gear engaged with the main gear for driving the main gear;
a plurality of cutting members configured to engage the plurality of cams, rotation of the main gear causing rotation of the cams to thereby cause the cutting members to move in a reciprocal manner; and
a separator plate attached to the housing, a portion of the separator plate being disposed between the plurality of cutting members to inhibit contact between the cutting members.

2. The gearbox of claim 1, wherein at least one end of the separator plate is attached to the housing with a major portion of the plate being spaced a distance from a portion of the housing.

3. The gearbox of claim 2, the major portion extending along a first plane, the end attached to the housing extending along a second plane, the first plane being spaced a distance vertically from the second plane.

4. The gearbox of claim 1, wherein the separator plate further comprises a pair of leg sections having an aperture located therebetween, the aperture being configured to receive the drive gear.

5. The gearbox of claim 1, wherein the main gear includes a shaft and the plurality of cams are attached to the shaft, and wherein the separator plate includes a hole extending therethrough for receiving the shaft.

6. The gearbox of claim 1, wherein the plurality of cams comprises a pair of eccentric cams and the plurality of cutting members comprises a pair of cutting members, each cutting member being configured to engage one of the cams, rotation of the main gear causing rotation of the cams to thereby cause the cutting members to move in an alternating, reciprocal manner.

7. The gearbox of claim 6, wherein one of the pair of cutting members is located vertically above the other cutting member, the separator plate being configured to inhibit contact between a superjacent cutting member and a subjacent cutting member.

8. The gearbox of claim 1, wherein the handheld power tool includes a hedge trimmer.

9. A gearbox for a handheld power tool, including:
a housing;
a main gear disposed within the housing and including a pair of eccentric cams attached thereto;
a drive gear engaged with the main gear for driving the main gear;
a pair of cutting members configured to engage the pair of cams, rotation of the main gear causing rotation of the cams to thereby cause the cutting members to move in a reciprocal manner; and
a separator plate including a main portion and a leg section, the leg section being secured to the housing and the main portion being disposed between the pair of cutting members to inhibit contact between the cutting members.

10. The gearbox of claim 9, wherein the main portion of the separator plate is spaced a distance from a portion of the housing.

11. The gearbox of claim 9, wherein the separator plate further comprises a pair of leg sections having an aperture located therebetween, the aperture being configured to receive the drive gear.

12. The gearbox of claim 9, wherein the main portion extends along a first plane, the leg section extends along a second plane, the first plane being spaced a distance vertically from the second plane.

13. The gearbox of claim 9, wherein the main gear includes a shaft and the cams are attached to the shaft, and wherein the separator plate includes a hole extending therethrough for receiving the shaft.

14. The gearbox of claim 9, wherein one of the pair of cutting members is located vertically above the other cutting member, the separator plate being configured to inhibit contact between a superjacent cutting member and a subjacent cutting member.

15. The gearbox of claim 9, wherein the handheld power tool includes a hedge trimmer.

16. A separator plate for use with a handheld power tool having a plurality of gears for driving a plurality of cutting members, the separator plate including:
a main portion having a hole extending therethrough; and
a leg section attached to the main portion and configured to be secured to a portion of the power tool, the main portion being configured to be disposed between the plurality of cutting members to inhibit contact between the cutting members.

17. The separator plate of claim 16, wherein the separator plate is configured to inhibit contact between a superjacent cutting member and a subjacent cutting member.

18. The separator plate of claim 16, further including a pair of leg sections having an aperture located therebetween, the aperture being configured to receive a gear.

19. The separator plate of claim 16, the main portion extending along a first plane, the leg section extending along a second plane, the first plane being spaced a distance vertically from the second plane.

20. The separator plate of claim 16, wherein the hole of the main section is configured to receive a rotating shaft.
